(19) United States
(12) Patent Application Publication
(10) Pub. No.: US 2014/0142987 A1
(43) Pub. Date: May 22, 2014

(54) System and Method for Automating Insurance Quotation Processes

(71) Applicants: Ryan Misch, Bloomington, IL (US); Tom Potter, Normal, IL (US); Joe Young, Downs, IL (US)

(72) Inventors: Ryan Misch, Bloomington, IL (US); Tom Potter, Normal, IL (US); Joe Young, Downs, IL (US)

(21) Appl. No.: 13/679,168

(22) Filed: Nov. 16, 2012

(51) Int. Cl. G06Q 40/08

(52) U.S. Cl. 705/4

(57) ABSTRACT

A system method for automating an insurance quotation are disclosed. The system and method may include receiving a first data set, the first data set related to an image of a first user data form, wherein the image has been subjected to a data integrity check prior to receipt, generating a second data set, the second data set related to the image of the first user data form, the second data set based at least on an OCR process applied to the first data set, and applying a plurality of business rules to the second data set in order to generate an insurance quotation.

### TECHNICAL FIELD

The present disclosure relates generally to methods and systems for automating the insurance quotation process, and particularly to automatically generating quotation information from driver information.

### BACKGROUND

Insurance companies use various types of customer information in order to generate a quotation for the cost of insurance services. For example, an insurance company may gather a customer's demographic information (name, age, place of residence, etc.), as well as information relating to the object to be insured. In the case of automobile insurance, the insurance company may gather information such as the make, model, and mileage of the vehicle to be insured. Typically, this information collection is done as a manual or on the part of the insurance company. For example, the customer may call an insurance agent to report the required data or may enter the required data into a form on a website.

These processes requiring manual data entry have several drawbacks, including increased time for the customer due to data collection, potential data integrity and/or accuracy issues, and delay in the customer obtaining a quotation.

### SUMMARY

A system method for automating an insurance quotation are disclosed. The system and method may include receiving a first data set, the first data set related to an image of a first user data form, wherein the image has been subjected to a data integrity check prior to receipt, generating a second data set, the second data set related to the image of the first user data form, the second data set based at least on an OCR process applied to the first data set, and applying a plurality of business rules to the second data set in order to generate an insurance quotation.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates an example system for automating a data gathering process for use in generating an insurance quotation process, in accordance with certain embodiments of the present disclosure;

FIG. 2 illustrates an example customer data form as the subject of an example data integrity check, in accordance with certain embodiments of the present disclosure; and

FIG. 3 is a flowchart of an example method for capturing customer data from one or more customer data form(s), in accordance with certain embodiments of the present disclosure.

### DETAILED DESCRIPTION

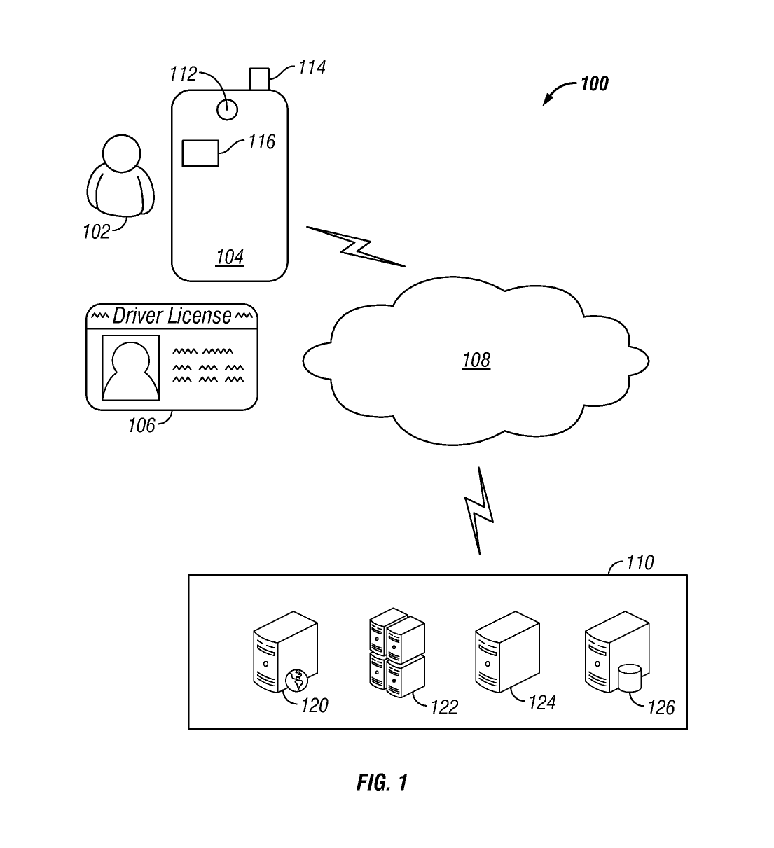

FIG. 1 illustrates an example system 100 for automating a data gathering process for use in generating an insurance quotation process, in accordance with certain embodiments of the present disclosure. In some embodiments, system 100 includes customer 102 using data capture device 104 and customer data form 106 to send customer insurance-related data to insurer 110 via network 108. Insurer 110 may then return data related to an insurance quotation to customer 102 via network 108. In some embodiments, this process may be completed without manual intervention from the insurer.

Customer 102 may be any entity interested in obtaining data related to an insurance quotation from insurer 110. For example, customer 102 may be an existing customer of insurer 110 or a prospective customer. Customer 102 may have one or more existing insurance policies with insurer 110 or none. In some embodiments, customer 102 may use data capture device 104 and customer data form 106 to send customer-related data to insurer 110 via network 108.

Data capture device 104 may be any electronic device configured to capture customer data from customer data form 106 and send customer-related data to insurer 110 via network 108. For purposes of this disclosure, an “electronic device” may include any device or aggregation of devices operable to process, transmit, or receive any form of data. For example, an electronic device may be a personal computer, tablet computer, cellular telephone, or any other suitable device. The electronic device may include memory (e.g., random access memory), one or more processing resources (e.g., a microcontroller, baseband processor, and/or central processing unit), and/or nonvolatile memory for storing data when the power to the electronic device has been removed. Additional component of the electronic device may be present depending on the type, size, form, and/or function of the electronic device. For example, an electronic device may include one or more port(s) and/or device(s) such as a keyboard, mouse, touch screen display, video display, etc., for communicating with external devices and/or users.

In some embodiments, data capture device 104 may be an electronic device communicatively coupled to data capture component 112 and network interface 114. Data capture component 112 may be any component of an electronic device configured to capture customer data from customer data form 106. For example, data capture component 112 may be a digital camera communicatively coupled with data capture device 104. In the illustrative example of FIG. 1, data capture device 104 may be a cellular telephone with an integrated digital camera. In other examples, data capture component 112 may be integrated into or remote from data capture device 104. For example, data capture device 104 may be a digital camera (for capturing an image) that may be plugged into a laptop computer (for transmission of the image).

Network interface 114 may be any appropriate interface configured to provide data capture device 104 with access to a data transmission network such as network 108. For example, network interface 114 may be a network interface card that provides access to a TCP-based network (e.g., a local area network), a cellular modem, and/or an external or internal antenna of a cellular telephone for connecting to a cellular radio network. Network interface 114 may be integrated into data capture device 104 (e.g., in the case of a cellular telephone) or communicatively coupled to data capture device 104 without being physically integrated (e.g., in the case of a laptop computer with cellular modem).

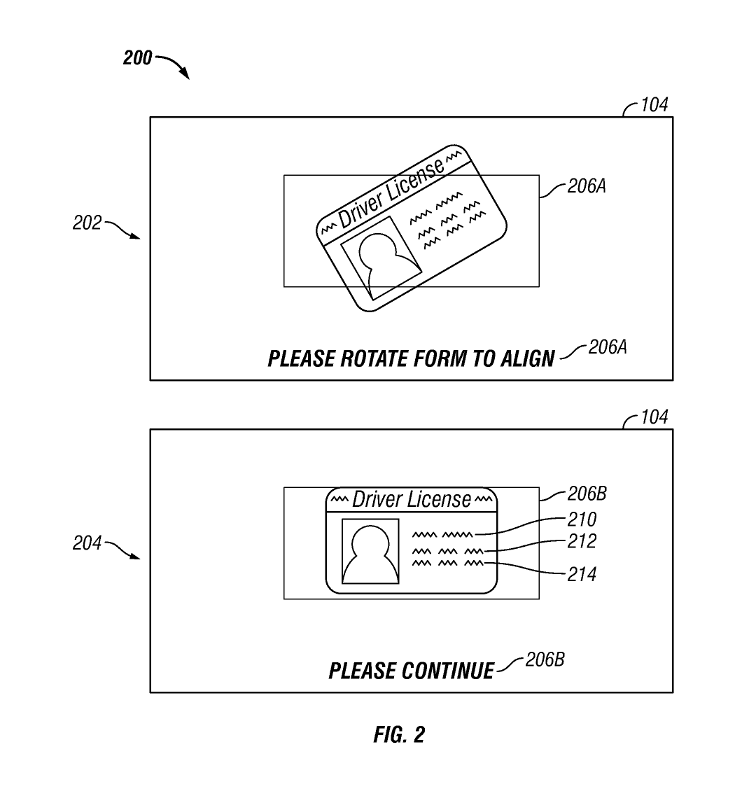

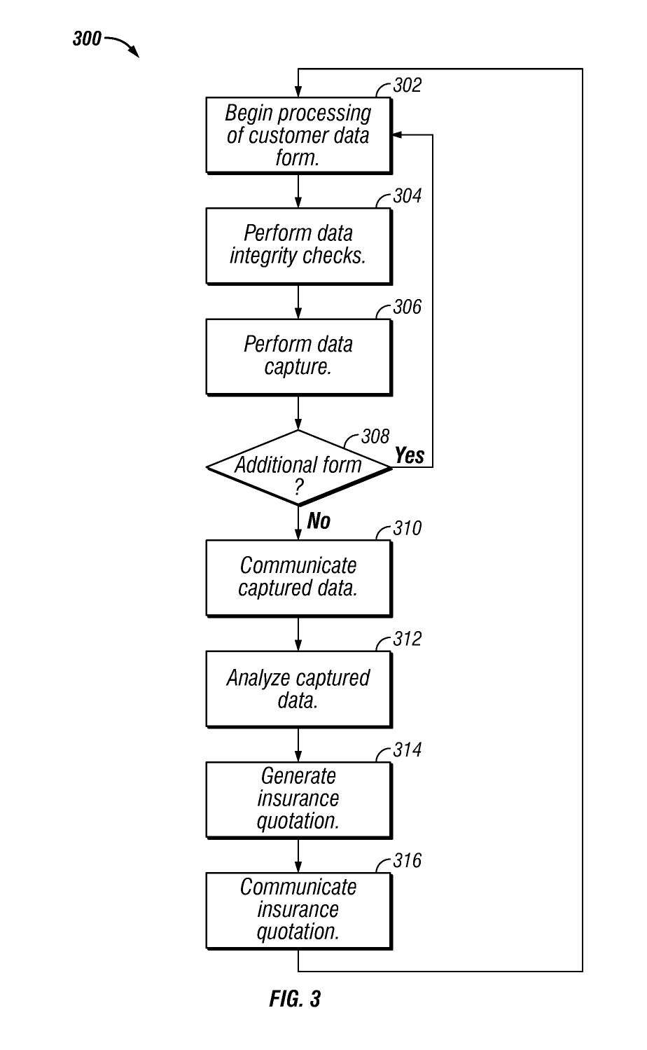

In operation, data capture device 104 may use data capture component 112 to capture certain data from customer data form 106 in order to transmit that data to insurer 110. As an illustrative example, data capture device 104 may be a cellular telephone equipped with an integrated digital camera and configured to transmit data via a cellular radio network to insurer 110. Customer 102 may take a picture of customer data form 106 and then transmit data related to that image to insurer 110. As described in more detail below and with reference to FIGS. 2-3, additional processing may, in some embodiments, be performed on the image prior to transmission. In the same or alternative embodiments, the image may be transmitted to insurer 110 without any further processing on the customer side.

In some embodiments, data capture device 104 may be further configured to include data processing module 116. Data processing module 116 may be any hardware, software, firmware, and/or any combination thereof configured to process data captured by data capture component 112 of data capture device 104. For example, data processing module 116 may be a software module or modules stored in non-volatile memory of data capture device 104 and configured to be executed by a processor of data capture device 104. In some embodiments, data processing module 116 may be a stand-alone module, while in the same or alternative embodiments, data processing module 116 may be distributed among multiple modules. As an illustrative example, data processing module 116 may be an application installed on a cellular telephone. An another illustrative example, data processing module 116 may be a piece of software installed locally on a laptop computer.

In operation, data processing module 116 may be configured to provide a user interface and/or data processing for customer 102 of the customer data captured from customer data form 106 prior to its transmission to insurer 110. For example, data processing module 116 may provide a user interface to guide customer 102 through the process of selecting customer data form 106, capturing the data from customer data form 106 using data capture component 112 of data capture device 104, transmitting the customer data from data capture device 104 to insurer 110 via network interface 114 and network 108. Data processing module 116 may also be configured to provide a user interface to guide customer 102 through a process of viewing an insurance quotation based at least on the transmitted data, as described in more detail below and with reference to FIGS. 2-3.

Customer data form 106 may be any object, form, card, or other representation of data where the data is placed in a standard or semi-standard format. For example, customer data form 106 may be a driver's license, proof of insurance form, etc. Data relating to customer 104 such as demographic data from the driver's license (e.g., age, residence, etc.) and/or data relating to the object to be insured (e.g., make, model, and mileage of a vehicle) from the proof of insurance form may be arranged within customer data form 106 in a standard or semi-standard way so as to facilitate the automated input of such data. Although certain data may be in a standardized location within customer data form 106, not all data may be so standardized. For example, a proof of insurance form may place information relating to the object to be insured in a standard location while moving other data (e.g., marketing data included on the form) to various locations throughout the form. As described in more detail below and with reference to FIGS. 2-3, insurer 110 may maintain a database of template customer data form(s) 106. So long as the data necessary for a customer insurance quotation may be obtained from customer data form 106 in a standardized location as compared to the stored templates, customer data form 106 may include other information unrelated to customer data.

In some embodiments, data capture device 104 may also be configured to determine whether data capture performed by customer 102 and/or data capture component 112 has been performed sufficiently such as to enable further data processing, as described in more detail below with reference to FIGS. 2-3. That is, further data processing may require some level of data integrity checking as a way to more efficiently process customer data. For example, it may be more efficient to identify errors in data entry prior to processing than to process error-prone data, reject said data, correct said data, and repeat the processing.

In some embodiments, data integrity checking may include determining whether the data captured by data capture component 112 from customer data form 106 was done in a manner sufficient to enable the further processing of customer data, as described in more detail below with reference to FIGS. 2-3. For example, customer 102 may use data capture component 112 of data capture device 104 to capture information from customer data form 106. Customer 102 may take a picture of his/her driver's license. In order to efficiently process the customer data contained within this type of customer data form 106, data capture device 104 (e.g., through data processing module 116) may determine whether the picture was taken (or is being taken) sufficiently straight, in sufficient light, and/or with sufficient clarity.

In some embodiments, data integrity check(s) may be performed concurrently with data capture. In the same or alternative embodiments, data integrity check(s) may be performed after data capture but prior to data transmission. For example, data processing module 116 may provide feedback to customer 102 during data capture to ensure quality data. As an illustrative example, and as described in more detail below with reference to FIGS. 2-3, data processing module 116 (e.g., an application installed on a cellular telephone) may provide a red light/green light warning system to customer 102 when customer 102 is attempting to photograph his/her driver's license. When customer 102 has insufficiently aligned the driver's license with data capture component 112, the image presented to customer 102 may be a red light to indicate improper alignment. When customer 102 has sufficiently aligned the driver's license with data capture component 112, the image presented to customer 104 may be a green light to indicate proper alignment and that customer 102 should proceed with data capture.

Once customer 102 captures the relevant data from customer data form 106, he/she may transmit that data to insurer 110 via network 108. As described in more detail above, customer 102 may or may not perform additional processing on customer data prior to its transmission, depending on the particular configuration of system 100. For example, in some configurations it may be necessary or desirable to have as much processing done on the customer end as possible so as to maximize the processing time at insurer 110. In other configurations it may be necessary or desirable to have as little processing done on the customer end as possible so as to minimize the requirements of data capture device 104. In an illustrative example, data capture device 104 may be a cellular telephone configured with a relatively lightweight application. The application may be configured to provide a user interface for customer 102 to take a picture of customer 102's driver's license and proof of insurance and then transmit those pictures to insurer 110. As described in more detail below and with reference to FIGS. 2-3, the optical character recognition, data processing, and quotation generation may all take place on insurer 110's side. Insurer 110 may then transmit data related to the insurance quotation to data capture device 104, which may the be displayed to customer 104 via the application.

In some embodiments, insurer 110 may receive user data from data capture device 104 via network 108. For example, data capture device 104 may transmit customer data to insurer 110 over a cellular radio network. Insurer 110 may, in some embodiments, include one or more server(s) configured to process the received user data and return an insurance quotation. For example, insurer 110 may include one or more web server(s) 120, application server(s) 122, OCR server(s) 124, and/or database server(s) 126, all communicatively coupled to one another. Although insurer 110 is illustrated as using four servers 120, 122, 124, 126 in system 100, it should be understood that insurer 110 may use fewer, more, or different server configurations without departing from the scope of the present disclosure. For example, insurer 110 may incorporate all data processing functionality onto a single physical machine. As another example, insurer 110 may distribute as much data processing as possible onto many different servers, none of which may be physically located near one another. As yet another example, some functionality may be combined while other remain separate. OCR server 124 may be integrated with application server 122, for example.

For purposes of the present disclosure, a server may be any hardware, software, firmware, and/or any combination thereof configured to provide server-related functionality. Server may include the physical computing machine or machines, physically located together or remotely, configured to execute instructions embodying the server functionality, as well as the instructions themselves, stored on computer-readable media and configured to be executed by the processor.

In some embodiments, web server 120 may be any server configured to provide network-based access to application server 122. For example, web server 120 may be an Apache web server, XML gateway, or other server configured to allow remote application to access applications residing on application server 122. In the illustrative example of system 100, web server 120 may be a web server configured to allow data capture device 104 to communicate user data to application server 122. In some embodiments, insurer 110 may include one or more web server(s) 120, depending on the type of remote access requested or required. For example, data capture device 104 may transmit data to insurer 110 over network 108, where network 108 may be a local area network. As an additional example, data capture device 104 may transmit data to insurer 110 over network 108, where network 108 may be a cellular network. Insurer 110 may include multiple web server(s) 120 to accommodate the different types of communication protocols required. Web server 120 may then be configured to transmit data (or allow data to be transmitted to application server 122).

In some embodiments, application server 122 may be any server configured to perform data processing on user data submitted to insurer 110 by data capture device 104. For example, application server 122 may be configured to apply customer data supplied by customer 102 via data capture device 104 to insurer's 110 insurance quotation engine to generate a quotation for customer 104. In some configurations, insurer 110 may have a set of predetermined rules for generating an insurance quotation for customer 102. For example, insurer 110 may include a set of actuarial tables that dictate a certain insurance rate given a customer's demographic and vehicle information.

In some embodiments, application server 122 may be configured to return a complete quotation to customer 102. In other embodiments, application server 122 may be configured to return only a partial and/or informative quotation to customer 102. Data provided by customer 102 to insurer 110 may determine whether a complete, partial, and/or informative quotation may be returned to customer 102. For example, in the case of an insurance quotation for automobile insurance, it may be possible to determine all information necessary for a complete quotation from customer data form(s) 106. In some configurations, it may not be possible to gather all information. For example, some types of customer data form 106 may not contain all necessary information (e.g., a particular type of proof of insurance may not include mileage of the vehicle). In the same or additional configurations, all information necessary to complete the quotation may not be generally available from customer data form(s) 106. For example, insurer 110 may require data related to customer 102's existing relationship with insurer 110 prior to completing a quotation. Such information may not be available from customer data form 106. In some embodiments, application server 122 may be configured to inform customer 102 that the quotation returned is incomplete and that customer 102 should contact insurer 110 through another channel in order to complete the quotation.

In some embodiments, application server 122 may be further configured to receive data from OCR server 124. OCR server 124 may be any server configured to extract data from an image. For example, as described in more detail above, data capture device 104 may capture information related to customer data form 106 in the form of an image. Data capture device 104 may then transmit that image to insurer 110. Insurer 110 may then receive that image at OCR server 124, which may then perform a process known as optical character recognition (“OCR”) on the image.

In some embodiments, OCR server 124 may be communicatively coupled to database server 126. In some embodiments, database server 126 may include a series of templates of customers data forms 106. OCR server 124 may be configured to determine what type of customer data form 106 is being analyzed and communicate that data to database server 126. OCR server 124 may then receive an identifier from database server 126 indicating which type of customer data form 106 is being analyzed. OCR server 124 may then use this identifier in order to determine where to look within the image to determine the appropriate user data. For example, as described in more detail below with reference to FIG. 2, database server 126 may identify the image received from customer 102 as being an Illinois driver's license. OCR server 124 may then use this information to determine that customer's 102 name, address, age, and other demographic information may be found at the appropriate image locations. In the same or alternative embodiments, one or more database server(s) 126 may include other types of information relevant to the generation of an insurance quotation. For example, database server 126 may store the business rules used by application server 122 to generate the insurance quotation. As another example, database server 126 may include data related to insurer's 110 current customers 102. Application server 122 may be able to, in some embodiments, match customer 102 against insurer's 110 current list of customers 102 in order to provide customer 102 with a more accurate and/or detailed insurance quotation.

Although FIG. 1 describes an example system 100 wherein OCR server 124 and database server 126 are separate components, OCR server 124 and database server 126 may, in some embodiments, be combined or distributed in other manners. For example, OCR server 124 and database server 126 may be combined into a single application. As another example, application server 122, OCR server 124, and database server 126 may all be combined into a single server.

In operation, insurer 110 may receive data associated with customer 102 from data capture device 104. In some embodiments, this data may be received in the form of an image acquired by data capture component 112 of data capture device 104. Depending on the configuration of example system 100, this data may have undergone some preliminary processing by data processing module 116. In some embodiments, web server 120 of insurer 110 may negotiate access to application server 122 of insurer 110 with data capture device 104. Once access is granted, the customer data (e.g., in the form of an image) may be communicated to application server 122. A combination of application server 122, OCR server 124, and/or database server 126 may then take the data, parse it for particular pieces of data relevant to insurer 110, apply the relevant data to the insurer's business rules for generating an insurance quotation, generate that quotation based on the received data, and communicate the quotation back to customer 104 via network 108.

As an illustrative example, customer 102 may take a picture of his/her driver's license and proof of insurance with a digital camera built into his/her cellular telephone with the assistance of an application installed on his/her cellular telephone and provided by insurer 110. After ensuring that the pictures are taken appropriately and other data integrity measures taken, any processing of the data on customer's 102 side may occur. For example, the application may ask customer 102 to identify the state from which the driver's license issued. Customer 102 may then communicate the image data to insurer 110 via his/her cellular telephone. Once received, insurer 110 may identify the source of the images (e.g., a driver's license from the state of Illinois; proof of insurance from State Farm), perform a series of optical character recognition routines on the images in order to parse the relevant data, apply the data to a set of business rules (e.g., actuarial tables) to determine an insurance quotation (e.g., X dollar per Y months to insure Z automobile), which may then be communicated back to customer 102. Depending on the data parsed from customer data form(s) 106, the quotation provided by insurer 110 may be more or less complete.

FIG. 2 illustrates an example customer data form 106 as the subject of an example data integrity check 200, in accordance with certain embodiments of the present disclosure. In some embodiments, data integrity check 200 may include two potential outcomes (unsuccessful outcome 202, successful outcome 204) when customer 102 attempts to capture data within customer data form 106.

In some embodiments, customer data form 106 may include a plurality of demographic data fields 210, 212, 214. As described in more detail above with reference to FIG. 1, these data fields 210, 212, 214 may be recognizable by insurer 110 as containing data relevant to an insurance quotation for customer 102. Insurer 110 may be able to parse the data in data fields 210, 212, 214 and apply them to business rules resulting in an insurance quotation as described in more detail above.

In some embodiments, unsuccessful outcome 202 may include identifier 206A. Identifier 206A may be configured to communicate with customer 102 (or data capture device 104) in one form if data capture is currently not allowed, not preferable, and/or not optimal. For example, in the illustrative example provided, customer data form 106 may be customer's 102 driver's license. In example unsuccessful outcome 202, customer data form 106 is askew with respect to the desired reference frame. That is, the driver's license may be tilted relative to data capture component 112 (e.g., the digital camera's lens). In such a situation, it may be impractical or impossible to parse relevant data from such an image. As a result, identifier 206A may communicate with customer 102 that data capture should not proceed. For example, identifier 206A may be some combination of graphics, text, colors, or other signifiers capable of communicating the necessary information to customer 102. In the illustrative example, identifier 206A may include a red box (color not provided), as well as text indicating that customer 102 should rotate either customer data form 106 or data capture component 112.

In some embodiments, successful outcome 204 may include identifier 206B. Identifier 206B may be configured to communicate with customer 102 (or data capture device 104) in one form if data capture is currently not allowed, not preferable, and/or not optimal, as described in more detail below. In another form, identifier 206B may be configured to communicate with customer 102 (or data capture device 104) in another form if data capture is currently allowed, preferable, and/or optimal. For example, in the illustrative example provided, customer data form 106 may be customer's 102 driver's license. In example successful outcome 204, customer data form 106 may be sufficiently aligned with respect to the desired reference frame. That is, the driver's license may be sufficiently aligned relative to data capture component 112 (e.g., the digital camera's lens). In such a situation, it may be possible or optimal to parse relevant data from such an image. As a result, identifier 206B may communicate with customer 102 that data capture should proceed. For example, identifier 206B may be some combination of graphics, text, colors, or other signifiers capable of communicating the necessary information to customer 102. In the illustrative example, identifier 206B may include a green box (color not provided), as well as text indicating that customer 102 should proceed with data capture, for example by taking a picture including data fields 210, 212, 214.

In some embodiments, data integrity check 200 may be part of data processing module 106. In the same or alternative embodiments, data integrity check 200 may be part of data capture component 112, data capture device 104, or another component configured to provide appropriate data integrity checks for customer data. As described in more detail above with reference to FIG. 1, the data integrity checks may be part of the preprocessing of customer data performed by data capture device 104 prior to communicating customer data to insurer 110.

FIG. 3 is a flowchart of an example method 300 for capturing customer data from one or more customer data form(s) 106, in accordance with certain embodiments of the present disclosure. In some embodiments, method 300 may include steps 302-12. Although illustrated as discrete steps, various steps may be divided into additional steps, combined into fewer steps, or eliminated, depending on the desired implementation.

In some embodiments, method 300 may begin at step 302, in which method 300 may begin processing of customer data form 106. For example, customer 102 may identity the desire for an insurance quotation from insurer 110, as described in more detail above with reference to FIGS. 1-2, and launch an application installed on his/her cellular telephone. After beginning the processing, method 300 may proceed to step 304.

At step 304, method 300 may undertake any necessary data integrity checks on customer data form 106. For example, as described in more detail above with reference to FIGS. 1-2, data capture device 104 may ensure that the picture taken of customer data form 106 is sufficiently aligned so as to allow the parsing of customer data from the image. After performing the data integrity checks, method 300 may proceed to step 306.

At step 306, method 300 may capture data from customer data form 106. For example, customer 102 may proceed with taking the picture of his/her driver's license as described in more detail above with reference to FIGS. 1-2. Once data capture has occurred, method 300 may proceed to step 308.

At step 308, method 300 may determine whether additional customer data forms 106 are requested. If no other customer data forms 106 are requested, method 300 may proceed to step 310. If additional customer data forms 106 are requested, method 300 may return to step 302.

At step 310, method 300 may transmit the captured customer data to insurer 110. After communicating the data, method 300 may proceed to step 312, wherein insurer 110 may analyze the captured data. As described in more detail above with reference to FIGS. 1-2, this analysis may include an OCR process to parse relevant data from the communicated customer data. After analyzing the data, method 300 may proceed to step 314.

At step 314, method 300 may generate an insurance quotation from the analyzed data, as described in more detail above with reference to FIGS. 1-2. After generating the insurance quotation, method 300 may proceed to step 316, at which point the quotation may be communicated to customer 102. After communicating the quotation to customer 102, method 300 may return to step 302 in order to wait for customer 102 to initiate a new quotation process.

One of ordinary skill in the art will appreciate that, for this and other processes and methods disclosed herein, the functions performed in the processes and methods may be implemented in differing order. For example, as described in more detail above with reference to FIGS. 1-2, data integrity checks may be performed prior to and/or after data capture, as well as after data communication. Additionally, the steps and operations illustrated are provided as examples, and some may be optional, combined into fewer steps, and/or expanded into additional steps and operations without detracting from the essence of the disclosed embodiments. For example, method 300 may communicate the data captured from a first customer data form 106 prior to capturing data from a second customer data form 106. Although the present disclosure has been described in detail, it should be understood that various changes, substitutions, and alterations can be made hereto without departing from the spirit and the scope of the disclosure as defined by the appended claims.

1. An insurance quotation automation system comprising:
a database configured to store a plurality of template user data forms that each identify a location of customer data on a corresponding user data form;
an optical character recognition (“OCR”) server communicatively coupled to an application server, the OCR server configured to:
receive a first data set, the first data set related to an image of a first user data form wherein the image has been subjected to a data integrity check prior to receipt by the OCR server; and
generate a second data set related to the image of the first user data form, the second data set based at least on an OCR process applied to the first data set, wherein the OCR process compares the image of the first user data form to the template user data form to locate customer data in the image of the first user data form; and the application server configured to:
receive the second data set; and
apply a plurality of business rules to the second data set in order to generate an insurance quotation.

2. The insurance quotation automation system of claim 1, wherein the application server is further configured to:
receive a third data set related to an image of a second user data form, wherein the image has been subjected to a data integrity check prior to receipt by the application server; and
apply the plurality of business rules to the second data set and the third data set in order to generate the insurance quotation.

3. The insurance quotation automation system of claim 1, wherein the insurance quotation comprises an insurance quotation for automobile insurance.

4. The insurance quotation automation system of claim 1, wherein the data integrity check comprises a check of whether the first user data form is appropriately aligned.

5. The insurance quotation automation system of claim 1, wherein the first user data form comprises a driver's license.

6. The insurance quotation automation system of claim 1, wherein the first user data form comprises a proof of insurance form.

7. An insurance quotation automation system comprising:
a database configured to store a plurality of template user data forms that each identify a location of customer data on a corresponding user data form;
a processor;
a computer-readable medium communicatively coupled to the processor and having stored thereon instructions configured to, when executed by the processor:
receive a first data set, the first data set related to an image of a first user data form, wherein the image has been subjected to a data integrity check prior to receipt;
generate a second data set, the second data set related to the image of the first user data form, the second data set based at least on an OCR process applied to the first data set, wherein the OCR process compares the image of the first user data form to the template user data form to locate customer data in the image of the first user data form;
apply a plurality of business rules to the second data set in order to generate an insurance quotation.

8. The insurance quotation automation system of claim 7, wherein the instructions are further configured to, when executed by the processor:
receive a third data set, the third data set related to an image of a second user data form, wherein the image has been subjected to a data integrity check prior to receipt by the application server; and
apply the plurality of business rules to the second data set and the third data set in order to generate the insurance quotation.

9. The insurance quotation automation system of claim 7, wherein the insurance quotation comprises an insurance quotation for automobile insurance.

10. The insurance quotation automation system of claim 7, wherein the data integrity check comprises a check of whether the first user data form is appropriately aligned.

11. The insurance quotation automation system of claim 7, wherein the first user data form comprises a driver's license.

12. The insurance quotation automation system of claim 7, wherein the first user data form comprises a proof of insurance form.

13. A method for automating an insurance quotation, the method comprising:
storing a plurality of template user data forms that each identify a location of customer data on a corresponding user data form;
receiving a first data set, the first data set related to an image of a first user data form, wherein the image has been subjected to a data integrity check prior to receipt;
generating a second data set at least through an OCR process, the second data set related to the image of the first user data form, and the second data set based at least on the OCR process applied to the first data set, wherein the OCR process compares the image of the first user data form to the template user data form to locate customer data in the image of the first user data form; and
applying a plurality of business rules to the second data set in order to generate an insurance quotation.

14. The method of claim 13, further comprising:
receiving a third data set, the third data set related to an image of a second user data form, wherein the image has been subjected to a data integrity check prior to receipt by the application server; and
applying the plurality of business rules to the second data set and the third data set in order to generate the insurance quotation.

15. The method of claim 13, wherein the insurance quotation comprises an insurance quotation for automobile insurance.

16. The method of claim 13, wherein the data integrity check comprises a check of whether the first user data form is appropriately aligned.

17. The method of claim 13, wherein the first user data form comprises a driver's license.

18. The method of claim 13, wherein the first user data form comprises a proof of insurance form.
